(19) United States
(12) Patent Application Publication
(10) Pub. No.: US 2009/0177354 A1
(43) Pub. Date: Jul. 9, 2009

(54) METHOD FOR VEHICLE FAULT DIAGNOSIS USING AUDIO SENSORS

(75) Inventors: Dakshi Agrawal, Monsey, NY (US); Chatschik Bisdikian, Chappagua, NY (US); Bong Jun Ko, Harrington Park, NJ (US); Kang-Won Lee, Nanuet, NY (US); Vasileios Pappas, Elmsford, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/971,419

(22) Filed: Jan. 9, 2008

(51) Int. Cl. G01M 15/00

(52) U.S. Cl. 701/35

(57) ABSTRACT

A method for implementing vehicle diagnostics includes: receiving one or more sound signals from a series of sensors distributed and positioned in various operational areas of a vehicle; recording the one or more sound signals in response to a command generated by an operator of the vehicle; storing the one or more sound signals in persistent memory; processing the one or more sound signals; and selecting one or more of the processed sound signals for audio playback in response to a user command; and wherein the audio playback is configured to assist in the diagnosis and prevention of vehicle faults and component defects.

### BACKGROUND OF THE INVENTION

1. Field of the Invention

This invention relates generally to vehicle fault diagnostics, and more particularly to a method for diagnosing and troubleshooting abnormal vehicle conditions with a series of audio sensors, recording devices, and audio signal processing equipment.

2. Description of the Related Art

A vehicle's component systems and performance parameters are diagnosed in various ways including: visual inspection in operation or at rest, by listening to the sounds they make while running under varying operational conditions, or by electronic diagnostic systems and onboard computers. Among these, audible indication of faults may be the most difficult to diagnose, since in many instances the sounds generated by a vehicle's faulty parts only manifest themselves when the vehicle is being driven, and under specific driving conditions.

Vehicles produce distinct operational background noises while being driven. The background noise depends on the vehicle's overall condition, including its age, condition (e.g. brakes, suspension, tires, for a car etc.), repair history, road condition (e.g. asphalt, coal-tar, wind condition etc.). The unique nature of vehicle operational noises creates difficulties when it comes to troubleshooting a problem in a vehicle. A vehicle owner normally gets used to the typical background noise of their vehicle, and is able to “filter” out the background noise from their auditory system. Typically, when the background noise characteristics change, the driver's auditory system makes a note of the change, and the driver makes a mental note of a potential problem.

### SUMMARY OF THE INVENTION

Embodiments of the present invention include a method for vehicle diagnostics, the method includes: receiving one or more sound signals from a series of sensors distributed and positioned in various operational areas of a vehicle; recording the one or more sound signals in response to a command generated by an operator of the vehicle; storing the one or more sound signals in persistent memory; processing the one or more sound signals; and selecting one or more of the processed sound signals for audio playback in response to a user command; and wherein the audio playback is configured to assist in the diagnosis and prevention of vehicle faults and component defects.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for diagnosing and troubleshooting abnormal vehicle conditions with a series of audio sensors, recording devices, and audio signal processing equipment.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a functional block diagram for implementing embodiments of the invention.

FIG. 2 illustrates an alternative functional block diagram for implementing embodiments of the invention.

FIG. 3 illustrates a flow chart for a method for diagnosing and troubleshooting abnormal vehicle conditions with a series of audio sensors, recording devices, and audio signal processing equipment according to embodiments of the invention.

The detailed description explains the preferred embodiments of the invention, together with advantages and features, by way of example with reference to the drawings.

### DETAILED DESCRIPTION

Presently, trial-and-error is the only method to troubleshoot a vehicle's impending problems that are described to a mechanic only by audible sounds heard by a driver. In addition, it is extremely difficult for the driver to convey subtle changes in the vehicle noise characteristics to the mechanic. The problem is compounded since the sound change may only be noticeable in certain driving situations, for instance, at high speeds, while driving a vehicle down a slope, or when the vehicle is in a certain gear, etc. Therefore, it is difficult to verbally present or recreate these subtle changes in noise at a vehicle repair shop. Typically, the mechanic manually inspects suspicious components, or connects the vehicle to a diagnostic station that looks at various characteristics (error codes from engine and vehicle computer diagnostic modules, amount of various chemical compounds in the exhaust, engine rpm etc.), and tries to diagnose the problem. However, the currently employed methods are time-consuming, and do not necessarily identify the root cause of the abnormal noise, which often results in multiple visits to the repair shop. Furthermore, all these solutions have a critical drawback—they exclude the vehicle's driver from the troubleshooting process. Accordingly, there is a need for a novel solution that may assist a driver to recreate the perceived vehicle noise at a later time for better fault and performance diagnosis.

Embodiments of the invention provide a method and system for diagnosing and troubleshooting abnormal vehicle conditions with a series of audio sensors, recording devices, and audio signal processing equipment. In embodiments of the invention, several sensors are placed in strategic locations within a vehicle. The strategic locations within the vehicle may include locations near the major noise generating components of a vehicle, such as tires, engine block, transmission, belts, etc. The sensor may be of any type, but are primarily sound sensors, which are inexpensive and may be placed inside the vehicle in several strategic locations. Sound samples from these sensors are stored in a form of persistent memory such as non-volatile solid state memory. It is noted that while the exemplary embodiments considered herein are given within the context of fault diagnosis for road vehicles, such as automobiles (or cars), those skilled in the art may apply it within other contexts including vehicles in general, such as trucks, boats, planes, or even more generally for other sound-producing, motorized devices for which fault diagnosis takes place during periods other than their regular operational periods.

Embodiments of the invention provide a driver with a means for initiating a recording session upon hearing a strange sound, tagging the resultant recorded sound samples, and storing the sound samples in persistent memory within the vehicle. In an exemplary embodiment, a vehicle may be equipped (by the vehicle manufacturer or as an aftermarket installable option) with a “symptom button” that vehicle operators (e.g., vehicle drivers) may push when a disturbing noise occurs, and have related sound signals stored in a persistent memory device. Subsequently, when the vehicle is taken to a repair facility, a mechanic may put the stored sound signals in a computer analyzer. The computer analyzer plays back different components of the recorded vehicle noise, and asks the vehicle driver to identify which one component was disconcerting.

The sound samples recorded by the different sound sensors are a mix of sound components emanating from different components in the vehicle. The intensity of a particular sound component in a particular sensor recording will depend on its relative position with respect to the source of sound. The sound components may later be isolated from one another via signal processing techniques, such as channel identification to provide cleaner signals. After the components of sound are separated and played back to the vehicle's driver and a mechanic, the driver may have an enhanced ability to identify the disconcerting signal components to the mechanic. In addition, the mechanic is also assisted in their work, as the mechanic may better localize the source of the abnormal sound (based on noise characteristics such as the location of the sensor which was closest to the source of sound). Alternatively, the recorded sound samples may be matched with a series of known symptoms in a sound database, by a computerized diagnostic system, so that the diagnosis process may be partially or fully automated.

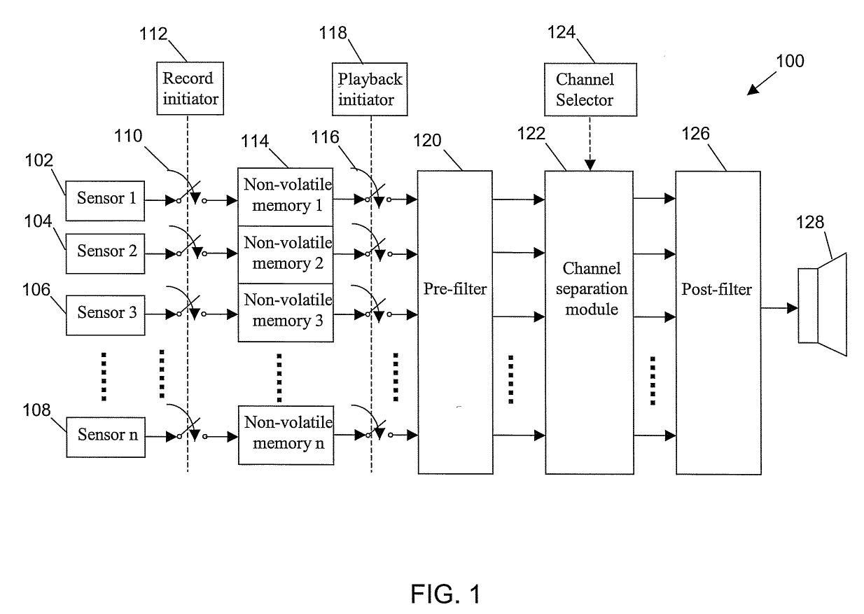

FIG. 1 illustrates a functional block diagram 100 for implementing embodiments of the invention. A series of sound sensors 1 through n (102, 104, 106, 108) are placed in strategic positions in the vehicle to capture the sounds generated while the vehicle is in operation. The sound captured by sensors may not necessarily be generated by a vehicle component itself (for example, the sound may be wind noise). When a driver notices an abnormal noise or strange sound from the vehicle, the driver starts the recording session by activating the record initiator 112. An example of the record initiator 112 is a push button located near the dashboard in front of the driver's seat or on the steering wheel. When the recording session starts (symbolized by closing switches 110), the sound sensors (102, 104, 106, 108) begin to record the sound, and send the recorded signals to a persistent memory device 114, which stores the recorded signals from each sensor in separate memory spaces 1 through n. The recording session may be stopped when the driver deactivates the record initiator (112), or automatically stopped via a predefined recording session time-out. The signals from the sound sensors (102, 104, 106, 108) include timing information. The timing information provides for synchronization of the separately recorded sound signals during a playback session. Furthermore, if the vehicle is equipped with a means for storing other time-stamped vehicle operation data, then the sound information captured with the sound sensors (102, 104, 106, 108) may be combined with additional time-stamped vehicle operational data. Examples of additional vehicle operation data include information captured by the vehicle's diagnostic and monitoring system that collect data from various sensors that track temperature, fluid levels, air pressure levels, engine rotation, and other parameters that are of monitoring interest in vehicles.

Continuing with FIG. 1, at a later time, the vehicle's driver or a mechanic starts the playback session by activating the playback initiator 118. The playback initiator 118 initiates the transfer (symbolized by closing switches 116) of recorded signals from the persistent memory 114 through a pre-filter 120 to a channel separation module 122 thru a post-filter 126 to a sound player 128 for audio playback.

The channel separation module 122 may use a variety of sound processing techniques to separate or highlight abnormal sounds present in the recorded signals. The channel separation module 122 exploits the fact that signals emanating from different vehicle components have different characteristics, such as differences in pitch and spectrum. For example, different component have different frequencies of repetitions, and the frequency of components in engine cylinders is different from that of a transmission, which in turn is different from that of tires.

An example of a sound processing technique is channel identification or channel separation, which is capable of identifying distinct sources of sound. For example, consider a room with n people with n microphones. Even if everyone is talking simultaneously, it is possible to do channel identification, and get n very clean signals, each signal consisting of the sound made by exactly one user (and all other users faded in the background). The channel separation isolates sound source as well as the sound made by the source. If the number of microphones is less then the number of sound sources, it is still possible to localize a sound of interest. Following analysis of the sounds by the channel separation module 122, the driver or the mechanic may use a channel selector 124 to specify which components of the recorded and processed signals should be re-produced and sent to the sound player 126 that plays back the processed sound samples.

In addition, the channel separation module 122 may use any of the independent component analysis (ICA) techniques that are well-known to those skilled in the art. In a particular embodiment of the invention, an implementation of fast ICA algorithm invented by Hyvarinen, Karhunen, and Oja is used. The functionality of the channel separation module 122 may be further enhanced by pre- and post-filtering of the sound signals. In order to isolate “disconcerting noise” from the rest of the sound signals, regular noise components such as road noise may be removed from recorded signal by a pre-filtering operation 120 before sending sound samples to the channel separation module 122. Similarly, after sound components are separated, they may be enhanced by post filtering operations 126, for example, filtering that enhances periodic patterns and plays back only patterns that occur with a certain frequency, etc.

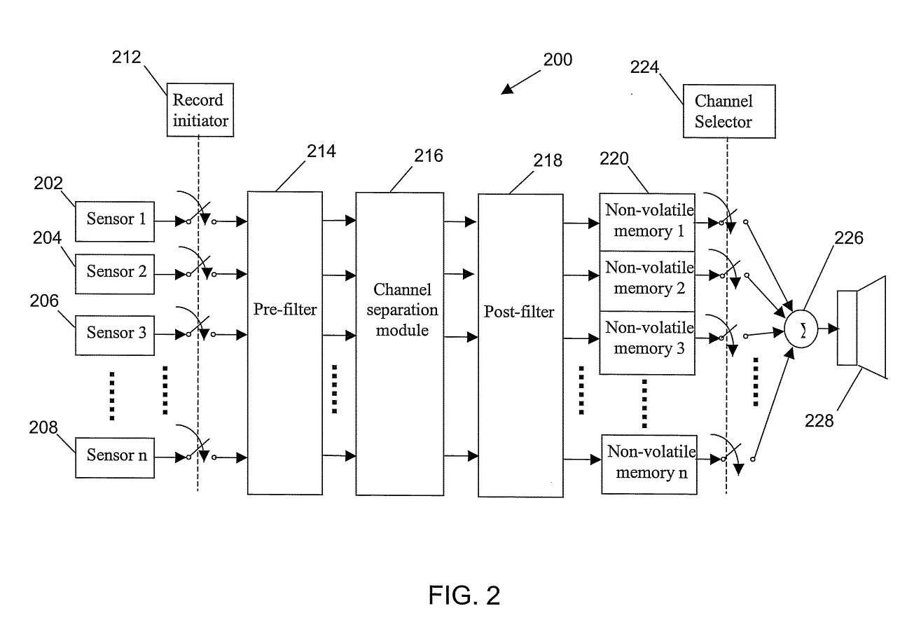

FIG. 2 illustrates an alternative functional block diagram 200 for implementing embodiments of the invention. In the embodiment of FIG. 2, the pre-filter 214, the channel separation module 216, and the post-filter 218 are placed between the sound sensors (202, 204, 206, 208) and the persistent memory device 220, which stores the recorded signals from each of the sound sensors (202, 204, 206, 208) in separate memory spaces 1 through n, are activated when the recording session starts. In this exemplary embodiment, the channel separation module 216 processes the sound signals and isolates the signals recorded by each sound sensor from one another in real time as the sound signals are recorded. Therefore, in this embodiment, the persistent memory 220 stores the isolated sound signals from different sound sensors (202, 204, 206, 208) in separate memory spaces 1 thru n. The separate isolated sound signals are chosen for playback, utilizing the channel selector 224, and may be aggregated or summed in summation block 226 for playback with sound player 228.

Embodiments of the invention may be used for implementing a manual diagnostic process by a mechanic, or alternatively the recorded sound samples may be searched and matched with a local or remote multimedia database that contains sound data that represent common component and vehicle system related problem symptoms. Leveraging multimedia search techniques developed for audio files, it is possible to search for sound records that are similar to the sound to be diagnosed. Using the search results, the mechanic can reduce the scope of the possible root causes of the problem, or double-check that their manual diagnosis actually matches the symptom analysis from a computerized tool, thereby improving the accuracy of problem diagnosis.

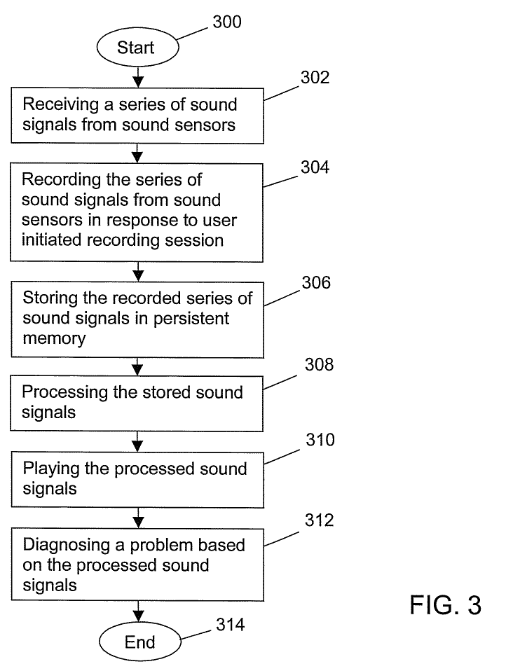

FIG. 3 illustrates a flow chart for a method for diagnosing and troubleshooting abnormal vehicle conditions with a series of audio sensors, recording devices, and audio signal processing equipment according to embodiments of the invention. The process starts (block 300) with the reception of sound signals from a series of sound sensors (block 302) that are positioned in strategic areas of the vehicle being observed. In response to a recording command from the vehicle's driver, the sound signals are recorded (block 304), and stored in persistent memory (block 306). Subsequently, the stored signals are processed, separated, and isolated (block 308) for playback by the driver or repair professional, to assist in the diagnoses of vehicle problems based on the sound related information (block 312), and the process concludes (block 314).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing vehicle diagnostics, the method comprising:
receiving one or more sound signals from a series of sensors distributed and positioned in various operational areas of a vehicle;
recording the one or more sound signals in response to a command generated by an operator of the vehicle;
storing the one or more sound signals in persistent memory;
processing the one or more sound signals; and
selecting one or more of the processed sound signals for audio playback in response to a user command; and
wherein the audio playback is configured to assist in the diagnosis and prevention of vehicle faults and component defects.

2. The method of claim 1, wherein the processing of the one or more sound signals comprises separating and isolating the one or more sound signals.

3. The method of claim 1, wherein the recording of the one or more sound signals is initiated in response to the vehicle's operator pushing a control button within the vehicle; and
wherein the recording stops as a result of at least one of the following: in response to the vehicle operator, and automatically via a predefined recording session timeout.

4. The method of claim 1, wherein the diagnosis of vehicle faults further comprises the matching the one or more processed sound signals with existing sound samples in a symptom database; and
wherein the matching of one or more processed sound signals with the existing sound samples assists in the potential identification of a root cause of the vehicle fault.

5. The method of claim 1, wherein the diagnosis of vehicle faults further comprises correlating the one or more processed sound signals with information derived from the vehicle's monitoring and diagnostic system.
